(19) United States
(12) Patent Application Publication
(10) Pub. No.: US 2021/0183256 A1
(43) Pub. Date: Jun. 17, 2021

(54) LANDING ASSISTANCE SYSTEM AND METHOD FOR AN AIRCRAFT UPON TOTAL FAILURE OF THE ENGINES OF THE AIRCRAFT

(71) Applicants: Airbus SAS, Blagnac (FR); Airbus Operations SAS, Toulouse (FR)

(72) Inventors: Elodie SABY, TOULOUSE (FR); Stéphanie BOUCHET, TOULOUSE (FR); Philippe CASTAIGNS, BLAGNAC (FR); Vincent SIBELLE, BLAGNAC (FR); Pascal ARNASSAN, BLAGNAC (FR); Laetitia MARQUIE, BLAGNAC (FR)

(21) Appl. No.: 17/117,571

(22) Filed: Dec. 10, 2020

(30) Foreign Application Priority Data
Dec. 13, 2019 (FR) 1914382

(51) Int. Cl. G08G 5/00; G01C 23/00; G08G 5/02

(52) U.S. Cl. CPC G08G 5/0056; G08G 5/0039; G08G 5/025; G01C 23/005

(57) ABSTRACT

An aircraft landing assistance system includes a processing unit configured to determine whether there is total failure of the aircraft's engines and, if yes, to determine a set of airports at which the aircraft could land from its current position, taking into account its current energy and current configuration. For each airport, the system determines a runway on which the aircraft could land and at least one possible landing direction of the aircraft on this runway and determines a reference point ahead of each runway, corresponding to a deployment point for the landing gear and a point of changing from a smooth configuration of the aircraft to a non-smooth configuration, to allow the aircraft to land on the runway. The system also commands the display, on an aircraft navigation screen, of a depiction of each of the runways and the reference points associated with these runways.

### CROSS-REFERENCES TO RELATED APPLICATIONS

This application claims the benefit of the French patent application No. 1914382 filed on Dec. 13, 2019, the entire disclosures of which are incorporated herein by way of reference.

### FIELD OF THE INVENTION

The invention relates to the field of landing assistance for an aircraft in the event of total failure of the engines of the aircraft, also called AEO (“all engines out”) or TEFO (“total engine flame out”).

### BACKGROUND OF THE INVENTION

During a flight of an aircraft, in the event of total failure of the engines, a pilot of the aircraft has to look for a diversion airport at which the aircraft could land in full safety, by gliding from its current position to a runway of the airport. In order to select a diversion airport, the pilot has to estimate the ability of the aircraft to glide to each of a plurality of airports from among the airports closest to its current position, taking into account its current configuration and its current energy. Such a diversion airport selection may thus correspond to a high workload for the pilot, even though he is still required to perform other tasks, such as, for example, making the aircraft safe in the short term, attempting to restart the engines, etc. In addition, a situation of total failure of the engines is exceptional and may sometimes lead to a stressful situation for the pilot. There is therefore a need to facilitate the task of selecting a diversion airport in a situation of total failure of the engines of an aircraft.

Document FR2912242 describes a system for assisting a pilot in the event of failure of an engine, with at least one other engine remaining functional. This method determines flight profiles of the aircraft to the closest airports, on the basis of flight strategies (minimal fuel consumption, minimal flight time, etc.). However, this method, even though it may also assist the pilot in a situation of total failure of the engines, is not completely suitable for such a situation.

### SUMMARY OF THE INVENTION

The present invention aims, in particular, to provide a solution to this problem. It relates to a landing assistance system for an aircraft upon total failure of the engines of the aircraft, the system comprising a processing unit configured so as to:

acquire, from at least one information source on board the aircraft, at least one item of information relating to the operation of the engines of the aircraft;

determine, on the basis of the at least one item of information relating to the operation of the engines of the aircraft, whether there is total failure of the engines of the aircraft; and

in the event of total failure of the engines of the aircraft:

determine a current total energy of the aircraft, a current position of the aircraft and a current configuration of the aircraft; and

determine a set of airports at which the aircraft could land from its current position, taking into account its current total energy and its current configuration.

The system is noteworthy in that the processing unit is furthermore configured so as to:

for each of the airports at which the aircraft could land, determine a runway on which the aircraft could land and at least one possible landing direction of the aircraft on this runway;

determine a reference point ahead of each determined runway, this reference point corresponding to a deployment point for the landing gear and a point of changing from a smooth configuration of the aircraft to a non-smooth configuration, so as to allow the aircraft to land on the runway;

for each reference point, determine a total energy margin of the aircraft that the aircraft should dissipate in order to rejoin the reference point from its current position; and

command the display, on a navigation screen of the aircraft, of a depiction of each of the determined runways, of a depiction of the reference points associated with these runways and of a depiction of the total energy margin associated with each reference point.

The landing assistance system thus provides the pilot with an indication of the airports at which the aircraft is able to land in full safety, by providing a depiction of the runways and of the reference points at which a pilot of the aircraft should command the deployment of the landing gear and the change from a smooth configuration to a non-smooth configuration in order to be able to land on these runways. The pilot is thus easily able to choose an airport at which he wishes to land. Displaying the reference point associated with each runway furthermore allows the pilot to easily view the direction in which it is possible to land the aircraft on a runway, thereby helping to facilitate the choice of an airport by the pilot.

According to one embodiment, the processing unit is configured so as to:

determine whether the aircraft is able to land on one of the runways in the two opposing directions of the runway; and

if the aircraft is able to land on the runway in its two opposing directions, determine a reference point for each landing direction of the aircraft on this runway and command the display, on the navigation screen of the aircraft, of a depiction of the two reference points associated with this runway.

According to various embodiments that may be taken in isolation or in combination:

the processing unit is configured so as to determine the total energy margin of the aircraft in the form of an elevation margin of the aircraft associated with each reference point and so as to command the display of a value of the elevation margin close to the depiction of the corresponding reference point;

the set of airports at which the aircraft could land from its current position corresponds at most to a predetermined number of airports, and the processing unit is configured so as to select these airports, from among all of the airports at which the aircraft could land from its current position, by selecting the airports having the longest runways;

the processing unit is configured so as to select the airports by taking into account, for each airport under consideration, the runway having the greatest length;

in order to command the display of the depiction of a runway on the navigation screen of the aircraft, the processing unit is configured so as to determine a length category of the runway and so as to command the display, on the navigation screen of the aircraft, of a runway symbol corresponding to this length category;

the processing unit is furthermore configured so as to determine the limit of a maximum area outside of which the aircraft will descend below a predetermined flight level, taking into account its current position, its current energy and its current configuration, and so as to command the display of the limit on the navigation screen of the aircraft;

the processing unit is configured so as to select the predetermined flight level by selecting, from among a set of predetermined flight levels, the flight level immediately below a current elevation of the aircraft;

the processing unit is furthermore configured so as to determine the limit of a maximum area within which the aircraft could land by gliding, taking into account its current position, its current energy and its current configuration, and so as to command the display of the limit on the navigation screen of the aircraft.

The invention also relates to a landing assistance method for an aircraft upon total failure of the engines of the aircraft, the method comprising the following steps implemented by a processing unit of a landing assistance system:

acquiring, from at least one information source on board the aircraft, at least one item of information relating to the operation of the engines of the aircraft;

determining, on the basis of the at least one item of information relating to the operation of the engines of the aircraft, whether there is total failure of the engines of the aircraft; and

in the event of total failure of the engines of the aircraft:

determining a current total energy of the aircraft, a current position of the aircraft and a current configuration of the aircraft; and

determining a set of airports at which the aircraft could land from its current position, taking into account its current total energy and its current configuration.

The method is noteworthy in that it furthermore comprises the following steps implemented by the processing unit of the landing assistance system:

for each of the airports at which the aircraft could land, determining a runway on which the aircraft could land and at least one possible landing direction of the aircraft on this runway;

determining a reference point ahead of each determined runway, this reference point corresponding to a deployment point for the landing gear and a point of changing from a smooth configuration of the aircraft to a non-smooth configuration, so as to allow the aircraft to land on the runway;

for each reference point, determining a total energy margin of the aircraft that the aircraft should dissipate in order to rejoin the reference point from its current position; and

commanding the display, on a navigation screen of the aircraft, of a depiction of each of the determined runways, of a depiction of the reference points associated with these runways and of a depiction of the total energy margin associated with each reference point.

The invention also relates to an aircraft comprising a landing assistance system as mentioned above.

### BRIEF DESCRIPTION OF THE DRAWINGS

The invention will be better understood on reading the following description and on examining the appended figures.

FIG. 1 schematically shows a landing assistance system according to one embodiment of the invention.

FIG. 2 shows an aircraft equipped with a landing assistance system according to one embodiment of the invention.

FIG. 3 illustrates one example of a display on a navigation screen of an aircraft.

FIG. 4 illustrates one example of a display on a navigation screen of an aircraft.

FIG. 5 illustrates one example of a display on a navigation screen of an aircraft.

FIG. 6 illustrates one example of determining a reference point associated with a runway.

### DETAILED DESCRIPTION OF THE PREFERRED EMBODIMENTS

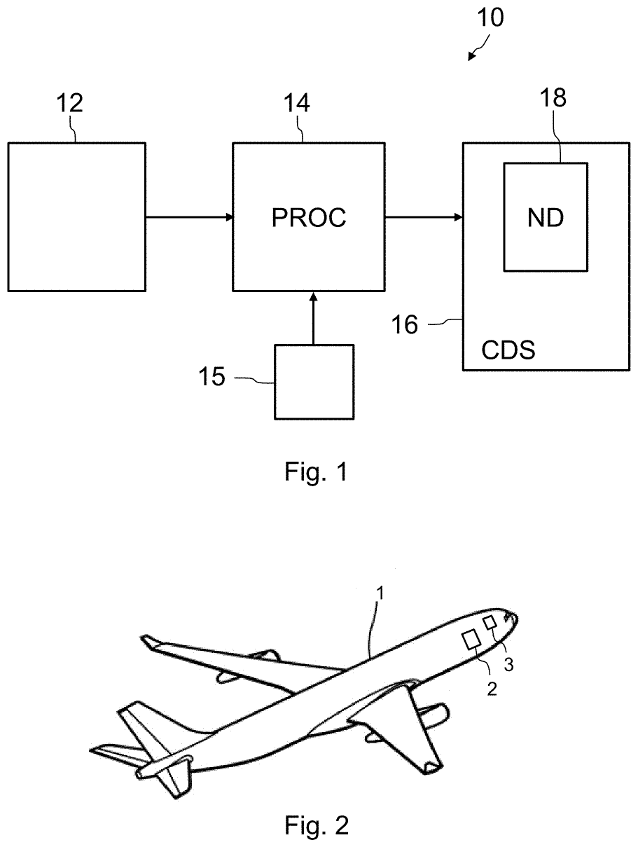

The landing assistance system 10 shown in FIG. 1 comprises a processing unit 14 (labelled PROC in the figure). The processing unit 14 is connected at an input to a set of information sources 12 of the aircraft. It is connected at an output to a display system 16, comprising a navigation screen of the aircraft (labelled ND in the figure for “Navigation Display”). The display system 16 is, for example, a CDS (“Cockpit Display System”). The set of information sources 12 comprises one or more first information sources corresponding to at least one avionic computer configured so as to provide one or more items of information relating to the operation of all of the engines of the aircraft, this or these items of information corresponding to the correct operation of the engines or to failure of the engines when such a failure occurs. The set of information sources 12 also comprises a second information source corresponding to at least one information source for the position of the aircraft, for example an inertial measurement unit of the aircraft and/or a receiver of a GNSS (“Global Navigation Satellite System”) satellite positioning system. The set of information sources 12 also comprises a third information source. According to a first alternative, the third information source corresponds to an information source configured so as to provide energy information of the aircraft. The energy of an aircraft, also called total energy, corresponds to the sum of its kinetic energy (dependent on its velocity) and its potential energy (dependent on its altitude or on its elevation with respect to the ground). According to a second alternative, the third information source corresponds to a subset of information sources configured so as to provide information for calculating the energy of the aircraft, for example, an information source for the velocity of the aircraft and an information source for the elevation of the aircraft with respect to the ground. The processing unit 14 is integrated, for example, into an avionics bay 2 of an aircraft 1, as shown in FIG. 2. The display system 16 is a display system of the cockpit 3 of the aircraft. In one particular embodiment, the processing unit corresponds to a processing unit of a flight management computer of the aircraft, for example an FMS (“Flight Management System”).

During operation, the processing unit 14 iteratively acquires, from the first information source, at least one item of information relating to the operation of the engines of the aircraft. In a first embodiment, this at least one item of information is an item of synthetic information for all of the engines of the aircraft. In a second embodiment, the processing unit 14 acquires an item of information relating to the operation of each of the engines of the aircraft. In this second embodiment, the information relating to the operation of the various engines is provided, for example, by the control computers of the engines, in particular a FADEC (“Full Authority Digital Engine Controller”) or an EEC (“Electronic Engine Controller”). On the basis of the at least one item of information relating to the operation of the engines of the aircraft, the processing unit 14 determines whether there is total failure of the engines of the aircraft.

In the event of total failure of the engines of the aircraft, the processing unit 14 determines a current total energy of the aircraft, a current position of the aircraft and a current configuration of the aircraft. To this end, the processing unit 14 acquires, from the second information source, at least one item of position information for the aircraft, on the basis of which it determines the current position of the aircraft. This item of position information is an item of three-dimensional position information, including an elevation of the aircraft with respect to the ground being flown over or an altitude of the aircraft. The total energy of the aircraft corresponds to the sum of its kinetic energy (dependent on its velocity) and its potential energy (dependent on its elevation or on its altitude). The processing unit also acquires at least one item of information from the third information source, on the basis of which it determines the current energy of the aircraft. The processing unit also acquires, from the set of information sources 12, at least one other item of information on the basis of which it determines a current configuration of the aircraft, for example: smooth configuration, flaps deployed, landing gear deployed, etc. This at least one other item of information is provided, for example, by an avionic computer of the aircraft.

The processing unit 14 determines a set of airports at which the aircraft could land from its current position, taking into account its current total energy and its current configuration. To this end, it acquires, from a database, information relating to airports located close to the current position of the aircraft and it determines, in a known manner, whether the aircraft is able to land at these airports, taking into account its current energy and its current configuration. In one embodiment, the database is a database on board the aircraft. In a first example, the database is integrated into a flight management computer of the aircraft. In a second example, the database is integrated on a server of the aircraft. Advantageously, when an airport has a plurality of runways, the processing unit determines the longest runway from among all of the runways of the airport. The processing unit then takes into consideration the longest runway for this airport. When an airport has a single runway, the processing unit determines that the airport has only the single runway, and it takes into consideration the single runway for this airport. Again advantageously, to determine the set of airports, the processing unit limits the set to a number N of airports corresponding to the N airports having the longest runways from among all of the airports at which the aircraft could land, the number N being a positive integer, for example between 5 and 10. This makes it possible to select airports at which it will be made easier to land the aircraft due to the longer length of their runways.

For each airport of the set of airports, the processing unit 14 furthermore determines at least one possible landing direction of the aircraft on the runway under consideration for this airport. Advantageously, the processing unit 14 determines whether the aircraft is able to land on the runway under consideration for an airport in the two opposing directions of the runway.

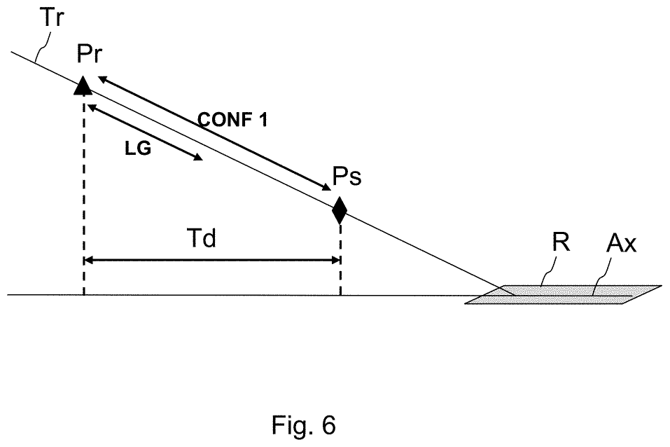

The processing unit 14 furthermore determines a reference point ahead of the runway under consideration for each airport, for each landing direction under consideration on this runway. This reference point is a point on a trajectory on which the aircraft approaches the runway, corresponding to a deployment point for the landing gear and a point of changing from a smooth configuration of the aircraft to a non-smooth configuration, so as to allow the aircraft to land on the runway. One example of determining a reference point is illustrated in FIG. 6. The reference point Pr is situated on a trajectory Tr on which the aircraft approaches the runway R, the trajectory Tr being aligned with the longitudinal axis Ax of the runway. As is conventional, when approaching a runway with a view to landing on this runway, the aircraft should be in what is called a stabilized state at a stabilization point Ps situated on the approach trajectory Tr. This stabilized state corresponds to a predetermined elevation and velocity of the aircraft. This elevation is for example 1000 ft. (approximately 330 m). The stabilization point Ps is generally determined in a manner counted down from a point of intersection between the approach trajectory Tr and the runway R. To be in the stabilized state, the aircraft should be in a non-smooth configuration, with the landing gear deployed. Therefore, advantageously, the reference point Pr is determined in a manner counted down from the stabilization point Ps, such that the landing gear is deployed and the aircraft is in a non-smooth configuration before the aircraft reaches the stabilization point Ps, if the pilot commands the deployment of the landing gear and the deployment of a non-smooth configuration when the aircraft crosses the reference point Pr. The deployment of the landing gear (illustrated by the arrow LG in the figure) and the deployment of the non-smooth configuration (illustrated by the arrow CONF1 in the figure) require longer times when the aircraft is in a situation of failure of all of the engines. These times depend, in particular, on the mass of the aircraft. In one exemplary embodiment illustrated in FIG. 6, the reference point Pr is determined so as to correspond to a flight time Td of the aircraft between it crossing the reference point Pr and it crossing the stabilization point Ps. This time Td is preferably a time predetermined so as to allow complete deployment of the landing gear and complete deployment of the non-smooth configuration before the aircraft reaches the stabilization point Ps. For a medium-haul aircraft, this time Td may be chosen, for example, to be equal to approximately 2 minutes. The reference point Pr is preferably determined by considering the velocity of the aircraft, when it crosses this reference point, to be equal to a velocity that makes it possible to maximize the flight distance of the aircraft by gliding in a smooth configuration. This velocity is generally also called “greendot” velocity for Airbus® aircraft. Upon total failure of the engines of an aircraft, the pilot of the aircraft generally chooses this velocity, which he is able to control through an appropriate angle of attack of the aircraft.

For each determined reference point, the processing unit 14 furthermore determines a total energy margin of the aircraft that the aircraft should dissipate in order to rejoin this reference point from its current position. This total energy margin corresponds to an excess energy of the aircraft with respect to a total energy value required for the aircraft to glide, at a particular trajectory, from its current position to the runway with which the reference point under consideration is associated. Advantageously, the processing unit 14 determines this total energy margin in the form of an elevation margin of the aircraft associated with each reference point. This elevation margin corresponds, for example, to a difference between the elevation of a point situated vertically to the reference point under consideration, this point being such that the aircraft is able to rejoin it by gliding along the particular trajectory from its current position, on the one hand, and the elevation of the reference point, on the other hand The particular trajectory of the aircraft is, for example, a most direct possible trajectory between the current position of the aircraft and the point situated vertically to the reference point, taking into account the current energy and the current configuration of the aircraft. Such a trajectory comprises, for example, a number of turns at most equal to two. It is such that it allows the aircraft to arrive vertically to the reference point while already being aligned with the axis of the runway.

The processing unit 14 then commands the display, on the navigation screen 18 of the aircraft, of a depiction of the longest runway of each of the airports of the set of airports, as well as depictions of the reference points associated with these runways. The pilot of the aircraft is thus easily able to view the runways of the airports of the set of airports on which the aircraft is able to land, as well as the reference points at which the aircraft should begin the transition from a smooth configuration, with the landing gear retracted, by flying at the “greendot” velocity, to a non-smooth configuration with the landing gear deployed, in order to be able to land on these runways with which these reference points are associated. Displaying the reference points, furthermore, allows the pilot to very easily see the direction in which the aircraft is able to land on the runways. Furthermore, when the aircraft is able to land on a runway in the two opposing directions of the runway and a reference point is displayed for each direction of the runway, the pilot is thus able to very easily view that the aircraft is able to land on this runway in its two opposing directions. The processing unit 14 also commands the display of a value of the elevation margin close to the depiction of the corresponding reference point. Displaying the values of elevation margins facilitates the choice of a runway by the pilot, by allowing him to know the elevation margin he has for landing on this runway. Having a sufficient elevation margin makes it possible to combat randoms, such as, for example, a change in wind direction or wind speed, a constraint relating to air traffic control, etc. The excess elevation margin may be absorbed by flying the aircraft between its current position and the reference point on a trajectory that is less direct than the particular trajectory under consideration by the processing unit 14.

Alternatively, rather than being determined and displayed in the form of an elevation margin, the total energy margin could, for example, be determined and displayed in the form of a distance margin.

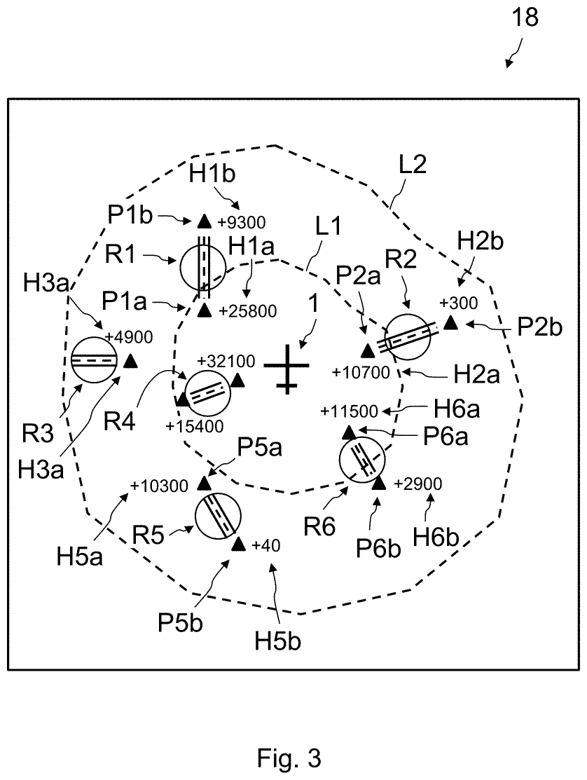

In the example illustrated in FIG. 3, the display on the navigation screen 18 comprises, at its center, a symbol depicting the position of the aircraft 1. The display comprises a depiction of the runways R1 . . . R6 of various airports at which the aircraft is able to land. In order to clarify the figure, the number N of airports is limited in this case to 6, but this number may in practice be greater, for example chosen within the interval [5; 10]. The display also comprises symbols P1a, P1b, P2a, P2b . . . P6a, P6b depicting the reference points corresponding to the runways R1 . . . R6. Except for the runway R3, two reference points are displayed for each of the runways. This allows the pilot to very easily view that the aircraft is able to land on these runways in their two opposing directions. A single reference point is displayed for the runway R3. This allows the pilot to very easily view that the aircraft is able to land on this runway in a single direction, oriented from right to left in the figure, since the symbol P3a corresponding to this reference point is situated to the right of the symbol depicting the runway R3. The display furthermore comprises elevation margin values H1a, H1b, H2a, H2b . . . H6a, H6b respectively associated with the symbols P1a, P1b, P2a, P2b . . . P6a, P6b depicting the reference points. Displaying the values of elevation margins facilitates the choice of a runway by the pilot, by allowing him to know the elevation margin he has for landing on this runway.

In one particular embodiment, in order to command the display of the depiction of a runway on the navigation screen of the aircraft, the processing unit determines a length category of the runway and it commands the display, on the navigation screen 18, of a runway symbol corresponding to this length category. In the example illustrated in FIG. 3, the various runways are depicted by way of three types of symbol corresponding to three length categories. Thus, the longest symbols are used to depict the runways R1 and R2, the shortest symbols are used to depict the runways R4 and R6, and the intermediate symbols are used to depict the runways R3 and R5. In one non-limiting example of the invention, the longest symbols correspond to runways with a length greater than 3.5 km, the shortest symbols correspond to runways with a length less than 2.5 km, and the intermediate symbols correspond to runways with a length between 2.5 km and 3.5 km. Using a limited number of types of symbols (for example three: long, short and intermediate) makes it easier for the pilot to comprehend the lengths of the runways due to the lengths being categorized. Having a runway with a long length makes it easier to land the aircraft on this runway, given that the braking capabilities of the aircraft are limited due to the total failure of the engines, since the thrust reversers are then unavailable.

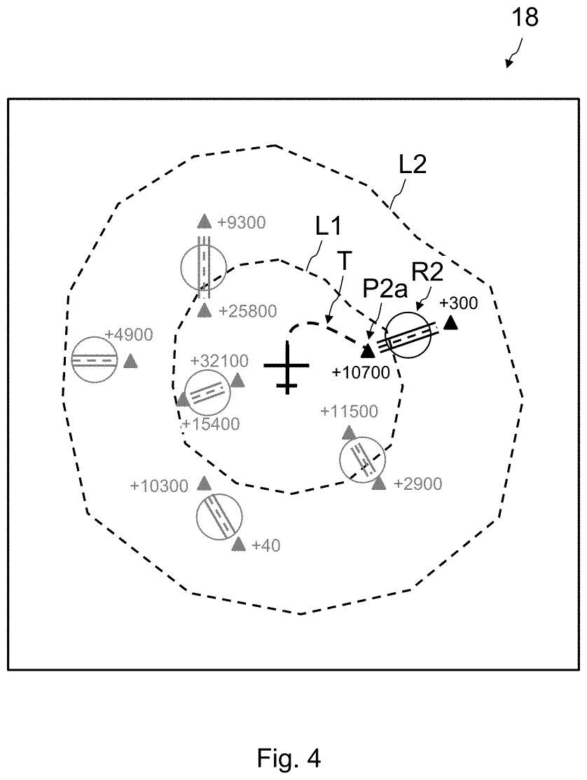

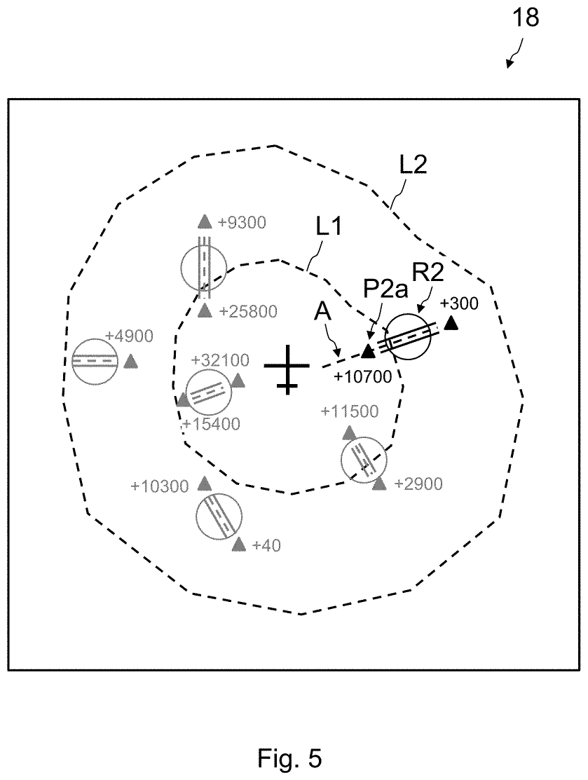

The pilot, who has a view of the lengths of the runways and of the elevation margins, is able to choose a runway that seems appropriate to him to land the aircraft. He may select this runway by way of a human-machine interface 15 of the cockpit of the aircraft. In a first example, the pilot may select the runway from a menu of the flight management computer. In a second example, he may select the runway on the navigation screen 18, by way of a pointing device of the human-machine interface 15. The processing unit 14 then commands highlighting of the runway under consideration on the navigation screen 18, for example by increasing the brightness of the symbol corresponding to this runway or by reducing the brightness of the symbols corresponding to the other runways. In one example shown in FIG. 4, in which the runway R2 is selected, the brightness of the symbols corresponding to the other runways is reduced. In a first particular embodiment illustrated in FIG. 4, when the runway R2 is selected with a view to landing with an approach crossing the reference point P2a, the processing unit 14 furthermore commands the display, on the navigation screen 18, of a depiction T of the most direct possible trajectory of the aircraft between the current position of the aircraft and the reference point P2a. In a second particular embodiment illustrated in FIG. 5, the processing unit 14 furthermore commands the display, on the navigation screen 18, of a depiction A of an extent, from the side of the reference point P2a, of a longitudinal axis of the selected runway.

The pilot may also request, by way of the human-machine interface 15, the display of additional information about the runway, such as, for example, the heading of the runway, a distance between the current position of the aircraft and the reference point associated with the runway, an estimated time of arrival at the reference point, also called ETA, etc.

In one embodiment, the processing unit furthermore determines the limit of a maximum area outside of which the aircraft will descend below a predetermined flight level, taking into account its current position, its current energy and its current configuration. The processing unit 14 commands the display of a depiction L1 of the limit on the navigation screen 18 of the aircraft. Advantageously, the processing unit 14 selects the predetermined flight level from among a set of predetermined flight levels (for example FL300, FL250, FL200, etc.), by selecting the flight level from the set immediately below a current elevation of the aircraft. For example, when the current elevation of the aircraft is 33000 ft. (that is to say, approximately 11000 meters), the immediately lower flight level (in the abovementioned example of a set of flight levels) is FL300, that is to say, 30000 ft. (approximately 10000 meters). The processing unit determines the limit for the flight level FL300 until the aircraft descends below the flight level. When the aircraft descends below the flight level FL300, the processing unit determines the limit for the immediately lower flight level, that is to say, FL250. The depiction L1 of the limit makes it possible to inform the pilot of the maximum distance that the aircraft is able to travel before descending to the flight level under consideration.

In one embodiment, the processing unit furthermore determines the limit of a maximum area within which the aircraft could land by gliding, taking into account its current position, its current energy and its current configuration. The processing unit 14 commands the display of a depiction L2 of the limit on the navigation screen 18 of the aircraft. Displaying the depiction L2 allows the pilot to easily take note of the maximum area within which the aircraft is able to land. This may assist him, for example, in giving preference, for safety reasons, to choosing a runway far enough away from the limit in order to conserve maneuvering margins for landing.

Preferably, the various calculations performed by the processing unit 14 take into account the surroundings of the aircraft, for example the wind, the topography of the ground being flown over, etc. This, in particular, explains the fact that the shape of the depictions of the limits L1 and L2, which is convex overall, is locally concave in the upper right-hand part of the display screen 18.

In one particular embodiment, the processing unit 14 is furthermore configured so as to receive a request from the pilot of the aircraft, via the human-machine interface 15, to simulate a situation of total failure of the engines of the aircraft. When it receives such a request, the processing unit 14 behaves in the same way as upon complete failure of the engines of the aircraft. This allows the pilot to verify the options for landing the aircraft from its current position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A landing assistance system for an aircraft upon total failure of all engines of the aircraft, said system comprising a processing unit configured to:
acquire, from at least one information source on board the aircraft, at least one item of information relating to an operation of the engines of the aircraft;
determine, based on said at least one item of information relating to the operation of the engines of the aircraft, whether there is total failure of the engines of the aircraft; and
in an event of total failure of the engines of the aircraft:
determine a current total energy of the aircraft, a current position of the aircraft and a current configuration of the aircraft; and
determine a set of airports at which the aircraft could land from its current position, taking into account its current total energy and its current configuration,
wherein the processing unit is furthermore configured to:
for each airport of said set of airports at which the aircraft could land, determine a runway on which the aircraft could land and at least one possible landing direction of the aircraft on this runway, taking into account its current total energy and its current configuration;
determine a reference point ahead of each determined runway, this reference point corresponding to a deployment point for a landing gear and a point of changing from a smooth configuration of the aircraft to a non-smooth configuration, so as to allow the aircraft to land on the runway;
for each reference point, determine a total energy margin of the aircraft that the aircraft should dissipate in order to rejoin the reference point from its current position; and
command a display, on a navigation screen of the aircraft, of a depiction of each of said determined runways, of a depiction of the reference points associated with these runways and of a depiction of the total energy margin associated with each reference point.

2. The system according to claim 1, wherein the processing unit is configured so as to:
determine whether the aircraft is able to land on one of said runways in two opposing directions of said runway; and
if the aircraft is able to land on said runway in the two opposing directions, determine a reference point for each landing direction of the aircraft on this runway and command a display, on the navigation screen of the aircraft, of a depiction of the two reference points associated with this runway.

3. The system according to claim 1, wherein the processing unit is configured to determine said total energy margin of the aircraft as an elevation margin of the aircraft associated with each reference point and to command a display of a value of said elevation margin close to a depiction of the corresponding reference point.

4. The system according to claim 1, wherein said set of airports at which the aircraft could land from its current position corresponds at most to a predetermined number of airports, and the processing unit is configured to select these airports, from among all of the airports at which the aircraft could land from its current position, by selecting the airports having a longest of all of the runways of all of the airports.

5. The system according to claim 4, wherein the processing unit is configured to select said airports by taking into account, for each airport under consideration, the runway having a greatest length.

6. The system according to claim 1, wherein, in order to command a display of the depiction of a runway on the navigation screen of the aircraft, the processing unit is configured to determine a length category of said runway and to command a display, on the navigation screen of the aircraft, of a runway symbol corresponding to this length category.

7. The system according to claim 1, wherein the processing unit is furthermore configured to determine a limit of a maximum area outside of which the aircraft will descend below a predetermined flight level, taking into account the current position of the aircraft, the current energy of the aircraft and the current configuration of the aircraft, and to command a display of said limit on the navigation screen of the aircraft.

8. The system according to claim 7, wherein the processing unit is configured to select said predetermined flight level by selecting, from among a set of predetermined flight levels, a flight level immediately below a current elevation of the aircraft.

9. The system according to claim 1, wherein the processing unit is furthermore configured to determine a limit of a maximum area within which the aircraft could land by gliding, taking into account the current position of the aircraft, the current energy of the aircraft and the current configuration of the aircraft, and to command a display of said limit on the navigation screen of the aircraft.

10. A landing assistance method for an aircraft upon total failure of all engines of the aircraft, said method comprising the following steps implemented by a processing unit of a landing assistance system:
acquiring, from at least one information source on board the aircraft, at least one item of information relating to an operation of the engines of the aircraft;
determining, based on said at least one item of information relating to the operation of the engines of the aircraft, whether there is total failure of the engines of the aircraft; and
in an event of total failure of the engines of the aircraft:
determining a current total energy of the aircraft, a current position of the aircraft and a current configuration of the aircraft; and
determining a set of airports at which the aircraft could land from the current position, taking into account the current total energy and the current configuration,
wherein said method furthermore comprises the following steps implemented by the processing unit of the landing assistance system:
for each of said airports at which the aircraft could land, determining a runway on which the aircraft could land and at least one possible landing direction of the aircraft on this runway, taking into account the current total energy of the aircraft and the current configuration of the aircraft;
determining a reference point ahead of each determined runway, this reference point corresponding to a deployment point for a landing gear and a point of changing from a smooth configuration of the aircraft to a non-smooth configuration, to allow the aircraft to land on the runway;
for each reference point, determining a total energy margin of the aircraft that the aircraft should dissipate in order to rejoin the reference point from the current position; and
commanding a display, on a navigation screen of the aircraft, of a depiction of each of said determined runways, of a depiction of the reference points associated with these runways and of a depiction of the total energy margin associated with each reference point.

11. An aircraft comprising a landing assistance system according to claim 1.
